(19) United States
(12) Patent Application Publication
(10) Pub. No.: US 2010/0141688 A1
(43) Pub. Date: Jun. 10, 2010

(54) IMAGE DISPLAY APPARATUS WITH MULTIPLE LAMPS AND CONTROL METHOD THEREOF

(75) Inventors: Kazunori Kotani, Nara-shi (JP); Hirofumi Kazumori, Kizugawa-shi (JP); Shigeyuki Hashizume, Shijonawate-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Osaka (JP)

(21) Appl. No.: 12/626,347

(22) Filed: Nov. 25, 2009

(30) Foreign Application Priority Data
Dec. 5, 2008 (JP) 2008-310973

(51) Int. Cl. G09G 5/10

(52) U.S. Cl. 345/690

(57) ABSTRACT

An image display apparatus includes a first lamp, a second lamp and a power supply unit for supplying electric power to the first or second lamp. In the image display apparatus, while a lamp to which electric power is to be supplied from the power supply unit is switched between the first lamp and the second lamp, the light generated by the first lamp or the second lamp is inhibited from being emitted outside.

### BACKGROUND OF THE INVENTION

1. Field of the Invention

The present invention relates to an image display apparatus, and particularly to an image display apparatus having a plurality of lamps supplied with electric power by a single power supply unit, and a method of controlling the image display apparatus.

2. Description of the Background Art

A lamp used for an image display apparatus such as projector is required to be driven with a high voltage for applying electric current to turn on the lamp. Various techniques concerning energization control for a lamp of an image display apparatus have been proposed for addressing such a requirement.

Document 1 (Japanese Patent Laying-Open No. 2003-229289) for example discloses a technique according to which the type of each of a plurality of high pressure discharge lamps is identified based on electrical characteristics or the like, and the high pressure discharge lamps are each operated at the rated wattage based on the identified type.

Document 2 (Japanese Patent Laying-Open No. 2003-215704) discloses a technique for an image display apparatus having a plurality of lamps, according to which deterioration of a lamp in use is detected before the lamp is dead or before control of the lamp output becomes impossible and, after a predetermined time from the time when a spare lamp is turned on in advance, the lamp in use is replaced with the spare lamp to be used for display of an image. Document 3 (Japanese Patent Laying-Open No. 2001-357984) discloses a technique according to which the lighting state of a lamp in use is detected and, if the detected lighting state is found to be abnormal, an off lamp is turned on and the lamp in use is extinguished after it is confirmed that the off lamp is turned on.

Document 4 (Japanese Patent Laying-Open No. 2004-157201) discloses a technique according to which a spare lamp to be used when a lamp in use fails is prepared, matching between the spare lamp and lighting circuit means is examined in advance and then the failing lamp is replaced with the spare lamp to be used.

Conventional image display apparatuses include a power supply unit dedicated to each lamp for supplying electric power to the lamp. Therefore, if an image display apparatus includes a plurality of lamps, the image display apparatus accordingly includes a plurality of power supply units, resulting in an increase in cost as well as volume and mass of the image display apparatus.

In conventional image display apparatuses, when the lamp to be used as a light source is switched from one lamp to another lamp among a plurality of lamps, respective physical positions of the lamps each used as a light source have to be replaced and accordingly, a mechanism for moving the lamps is necessary. The moving mechanism provided in the image display apparatus increases the cost of the image display apparatus, and also increases the volume and mass of the apparatus, which results in a problem of lack of convenience in installing and moving the apparatus.

Document 4 also discloses a technique according to which a plurality of lamps are connected to a single lighting circuit means, and a switch is inserted between the lighting circuit means and each lamp.

Document 4, however, does not disclose specific details of control performed when a lamp to be used is switched from one lamp to another lamp among a plurality of lamps, such as details of how the aforementioned switch is controlled.

Here, when a lamp being used is switched to another one, there may be any condition different from the one in normal use, and therefore, the manner of control for the lamp should be studied carefully.

### SUMMARY OF THE INVENTION

The present invention has been made in view of the circumstances above, and an object of the invention is to achieve a manner of control appropriate in switching a lamp to be used as a light source from one to another among a plurality of lamps provided in an image display apparatus.

An image display apparatus according to the present invention includes a first lamp, a second lamp, a power supply unit for supplying electric power to the first lamp or the second lamp, and a control unit for inhibiting light generated by the first lamp or the second lamp from being emitted outside, while a lamp to which electric power is to be supplied from the power supply unit is switched between the first lamp and the second lamp.

A method of controlling an image display apparatus according to the present invention is a method of controlling an image display apparatus including a first lamp, a second lamp and a power supply unit for supplying electric power to the first lamp or the second lamp, and light generated by the first lamp or the second lamp is inhibited from being emitted outside while a lamp to which electric power is to be supplied is switched between the first lamp and the second lamp.

According to the present invention, while a lamp to which electric power is to be supplied is switched from one to another among a plurality of lamps of the image display apparatus, light generated by the lamp is inhibited from being emitted to the outside of the image display apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration of a main portion of a projector implemented as an embodiment of an image display apparatus of the present invention.

FIG. 2 schematically shows a control block configuration of the projector in FIG. 1.

FIG. 3 is a flowchart for a lamp switching process performed by a control unit in FIG. 2.

FIGS. 4 to 11 each schematically show an example of flow of control signals in the projector in FIG. 1.

FIG. 12 is a flowchart for a modification of the lamp switching process in FIG. 3.

FIG. 13 illustrates a relation between a rated capacity for opening and closure of relay contacts of the projector in FIG. 1 and an electric power waveform when supply of electric power to a lamp is started.

FIG. 14 illustrates “control period in which instruction to switch lamp is invalidated” of the projector in FIG. 1.

### DESCRIPTION OF THE PREFERRED EMBODIMENTS

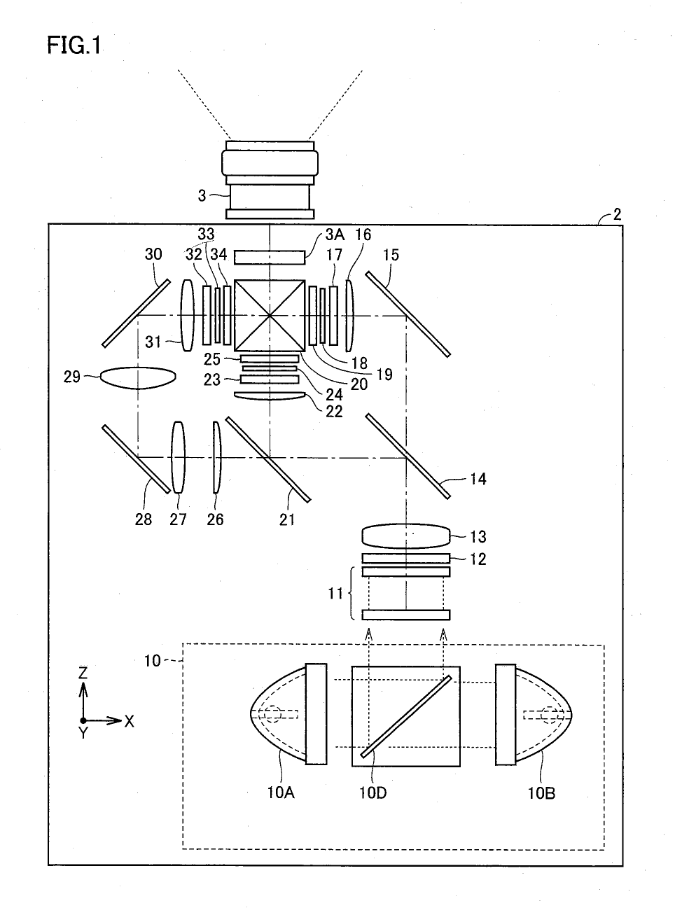

FIG. 1 schematically shows a configuration of a main portion of a projector implemented as an embodiment of the present invention.

Referring to FIG. 1, the projector includes an optical engine 2 and a projection lens 3, and the outside of the projector is covered with a casing (not shown). While the projector includes, for example, a component for audio output such as speaker, and a circuit board for electrically controlling the components of optical engine 2 and the audio output means, a part of the components including the aforementioned ones of the projector is not shown in FIG. 1.

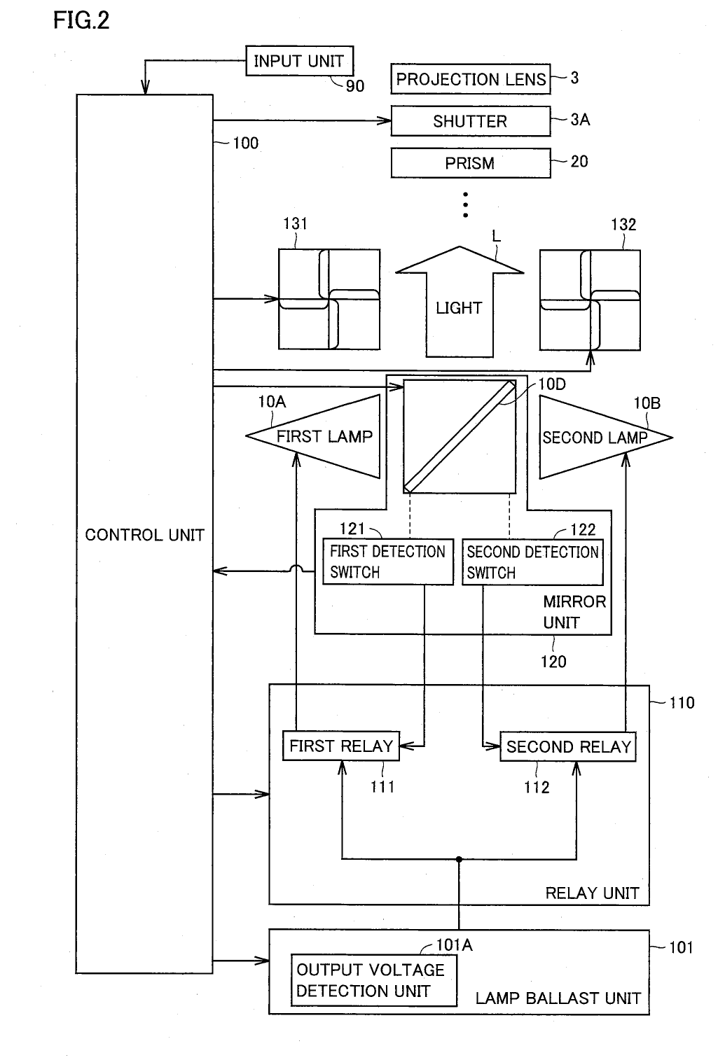

Optical engine 2 includes an illumination device 10. Illumination device 10 includes two lamps 10A, 10B and a mirror unit (mirror unit 120 shown in FIG. 2) for driving a mirror 10D, for example. Lamps 10A, 10B may be, for example, ultra-high pressure mercury lamp, metal halide lamp or xenon lamp. Light L from lamps 10A, 10B is emitted in the form of substantially parallel light rays by the action of a reflector.

Mirror 10D is rotatable about the Y axis located at a central portion of mirror 10D in FIG. 1. When lamp 10A is actuated, mirror 10D is caused to assume the state for directing the light from lamp 10A to a fly-eye integrator 11 as shown in FIG. 1. When lamp 10B is actuated, mirror 10D is rotated clockwise by 90° to assume the state for directing the light from lamp 10B to fly-eye integrator 11.

The light emitted from illumination device 10 proceeds via fly-eye integrator 11 to enter a PBS (polarized beam splitter) array 12 and a condenser lens 13. Fly-eye integrator 11 includes a fly-eye lens constituted of a group of lenses that appears to be an eye of a fly, and optically acts on the light from illumination device 10 so that the distribution of the quantity of light incident on liquid crystal panels 18, 24, 33 is uniform.

PBS array 12 is constituted of a plurality of PBSs and half-wave plates that are arranged in the form of an array, and causes the light rays from fly-eye integrator 11 to travel in one direction of polarization. Condenser lens 13 concentrates the light from PBS array 12. The light traveling through condenser lens 13 is then incident on a dichroic mirror 14.

Dichroic mirror 14 transmits only the light in the blue wavelength range (hereinafter “B light”), of the light from condenser lens 13, and reflects the light in the red wavelength range (hereinafter “R light”) and the light in the green wavelength range (hereinafter “G light”). The B light passing through dichroic mirror 14 is directed to and reflected by a mirror 15 and enters a condenser lens 16.

Condenser lens 16 optically acts on the B light so that the B light is incident on liquid crystal panel 18 in the form of substantially parallel light rays. The B light passing through condenser lens 16 is incident on liquid crystal panel 18 via an entry side polarization plate 17. Liquid crystal panel 18 is addressed according to an image signal for the blue color, and modulates the B light according to the addressed state. The B light modulated by liquid crystal panel 18 travels via an exit side polarization plate 19 to enter a dichroic prism (the term may be simply referred to as “prism” hereinafter) 20.

Of the light reflected by dichroic mirror 14, the G light is reflected by a dichroic mirror 21 to enter a condenser lens 22. Condenser lens 22 optically acts on the G light so that the G light is incident on liquid crystal panel 24 in the form of substantially parallel light rays. The G light passing through condenser lens 22 is incident on liquid crystal panel 24 via an entry side polarization plate 23. Liquid crystal panel 24 is addressed by an image signal for the green color and modulates the G light according to the addressed state. The G light modulated by liquid crystal panel 24 travels via an exit side polarization plate 25 to enter dichroic prism 20.

The R light traveling through dichroic mirror 21 enters a condenser lens 26. Condenser lens 26 optically acts on the R light so that the R light is incident on liquid crystal panel 33 in the form of substantially parallel light rays. The R light passing through condenser lens 26 proceeds along an optical path including relay lenses 27, 29, 31 for adjusting the optical path length and two mirrors 28, 30, and is incident on liquid crystal panel 33 via an entry side polarization plate 32. Liquid crystal panel 33 is addressed according to an image signal for the red color and modulates the R light according to the addressed state. The R light modulated by liquid crystal panel 33 travels via an exit side polarization plate 34 to enter dichroic prism 20.

Dichroic prism 20 combines the B light, G light and R light modulated respectively by liquid crystal panels 18, 24 and 33 into colored composite light, and causes the light to enter projection lens 3. Projection lens 3 includes a group of lenses for projecting the light to form an image on a projection plane, and an actuator for shifting a part of the lenses in the direction of the optical axis so as to adjust the state of zooming and the state of focusing an image to be projected. The colored composite light generated by dichroic prism 20 is enlarged and projected on a screen by projection lens 3.

In the projector of the present embodiment, a shutter 3A is disposed between projection lens 3 and dichroic prism 20. The projector of the present embodiment can close shutter 3A to hinder the light generated by lamp 10A or lamp 10B from being emitted via projection lens 3 to the outside.

FIG. 2 is a control block diagram of a main portion of the projector in the present embodiment.

Referring to FIG. 2, the projector includes a control unit 100 for entirely controlling operation of the projector. Control unit 100 includes a CPU (Central Processing Unit).

The projector also includes an input unit 90 for receiving external manipulation performed on the input unit. Input unit 90 may be a button provided on the surface of the casing covering the outside of the projector, or may be a soft key of a remote controller provided separately from the casing, or a button on a touch panel, for example. When input unit 90 is manipulated, information about the manipulation is input from input unit 90 to control unit 100.

The projector further includes mirror unit 120. Mirror unit 120 includes, in addition to mirror 10D, a drive mechanism (not shown) for driving mirror 10D. Mirror unit 120 also includes a first detection switch 121 for detecting whether or not mirror 10D is in a state of directing the light emitted from first lamp 10A to prism 20, and a second detection switch 122 for detecting whether or not mirror 10D is in a state of directing the light emitted from second lamp 10B to prism 20. Control unit 100 can obtain respective results of detection by first detection switch 121 and second detection switch 122.

Regarding mirror 10D, the state where the mirror directs the light emitted from first lamp 10A to prism 20 is herein referred to as first state, and the state where the mirror directs the light emitted from second lamp 10B to prism 20 is herein referred to as second state.

The projector further includes a lamp ballast unit 101 for supplying electric power of high voltage to first lamp 10A or second lamp 10B. From lamp ballast unit 101 to first lamp 10A, the electric power is supplied via a first relay 111. From lamp ballast unit 101 to second lamp 10B, the electric power is supplied via a second relay 112.

First relay 111 and second relay 112 are disposed in a relay unit 110, and the relays are opened or closed based on a signal that is output from control unit 100.

In the case where first detection switch 121 detects that mirror 10D is in the above-described first state and where a signal for closing the circuit is output from control unit 100 to relay unit 110, first relay 111 closes the circuit connecting lamp ballast unit 101 and first lamp 10A. The output representing the result of detection from first detection switch 121 is output to control unit 100 and independently to relay unit 110.

In the case where second detection switch 122 detects that mirror 10D is in the above-described second state and where a signal for closing the circuit is output from control unit 100 to relay unit 110, second relay 112 closes the circuit connecting lamp ballast unit 101 and second lamp 10B. The output representing the result of detection from second detection switch 122 is output to control unit 100 and independently to relay unit 110.

Lamp ballast unit 101 includes an output voltage detection unit 101A for detecting the output voltage value. Control unit 100 detects whether or not electric power is supplied from lamp ballast unit 101 to relay unit 110, based on the voltage value detected by output voltage detection unit 101A.

The projector further includes an exhaust fan 131 for cooling first lamp 10A, and an exhaust fan 132 for cooling second lamp 10B. Control unit 100 controls whether or not the fans are to be driven.

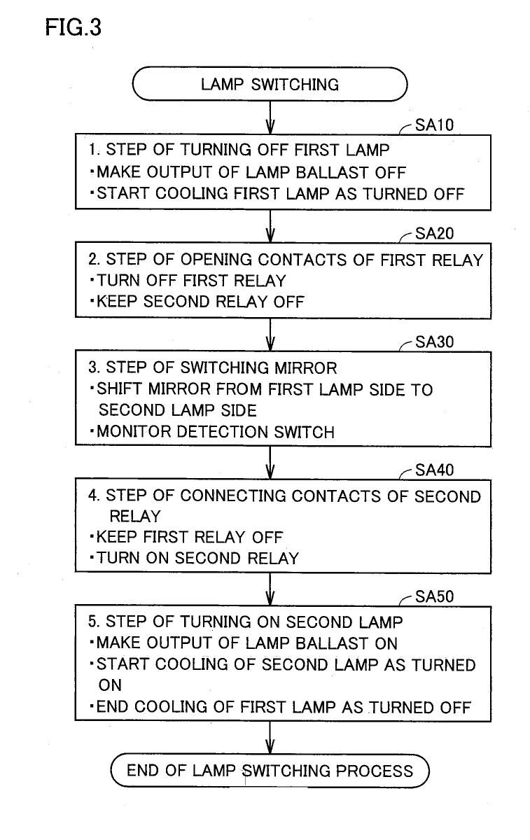

A description will now given of details of a process performed by control unit 100 of the projector in the present embodiment, for switching the lamp to be used as a light source from first lamp 10A to second lamp 10B (lamp switching process), with reference to FIG. 3 showing a flowchart for this process.

Referring to FIG. 3, in response to input of the fact that first lamp 10A fails as detected by output voltage detection unit 101A of lamp ballast unit 101, or the information that the lamp used as a light source is to be changed as input by input unit 90, control unit 100 performs the step of turning off first lamp 10A in step SA10.

In the step of turning off first lamp 10A, supply of electric power from lamp ballast unit 101 to relay unit 110 is stopped, and driving of exhaust fan 131 is started. Exhaust fan 131 may be continuously driven from the time when supply of the electric power to first lamp 10A is started.

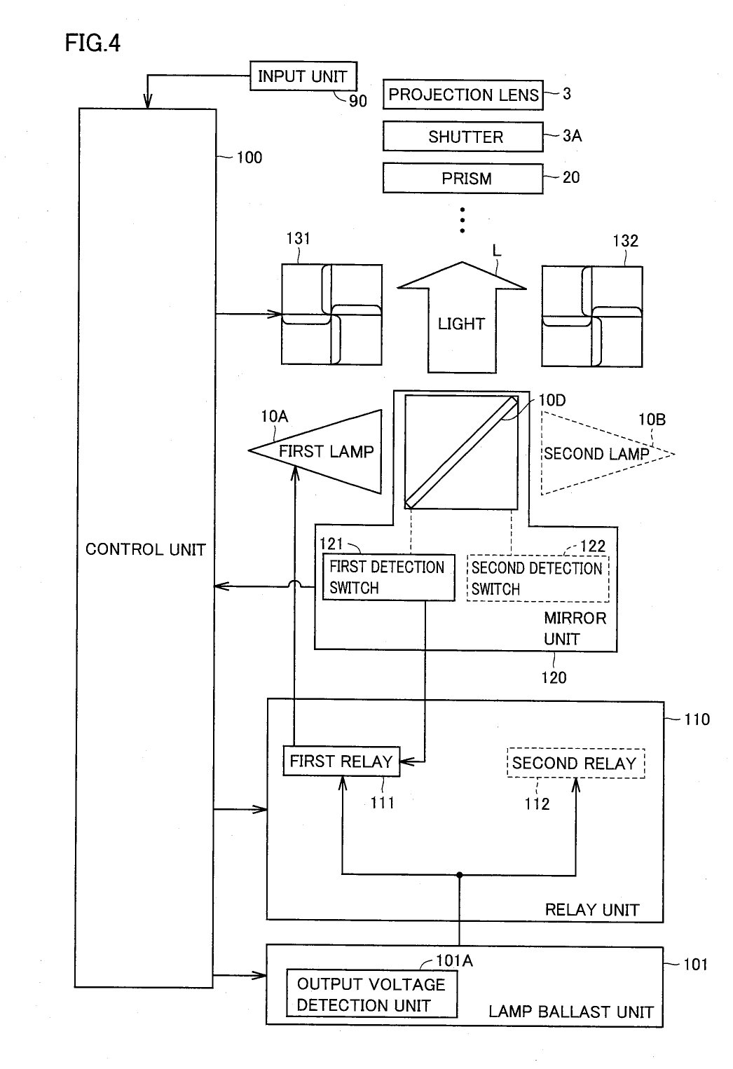

FIG. 4 schematically shows a flow of control signals when first lamp 10A is used as a light source, which is the state preceding step SA10.

Referring to FIG. 4, in the state as shown here, electric power is supplied from lamp ballast unit 101 to relay unit 110. In relay unit 110, first relay 111 is closed while second relay 112 is opened by control unit 100. Accordingly, the electric power supplied from lamp ballast unit 101 is not supplied to second lamp 10B but supplied to first lamp 10A.

In this state, based on the fact that mirror 10D is in the first state, first detection switch 121 outputs a signal of H (High). Based on the fact that mirror 10D is not in the second state, second detection switch 122 output a signal of L (Low). These signals are output to control unit 100 and also to relay unit 110.

When first lamp 10A is to be turned on for use as a light source, control unit 100 outputs a signal to relay unit 110 for turning on first relay 111, in response to input of the H signal from first detection switch 121.

When the signal for turning on first relay 111 is input from control unit 100 to relay unit 110, relay unit 110 closes first relay 111. In relay unit 110, in order to turn on first relay 111, drive electric power has to be supplied to first relay 111. Under the condition that the H signal is output from first detection switch 121, first relay 111 is supplied with the drive electric power.

Control unit 100 outputs to lamp ballast unit 101 a signal for starting supply of electric power to relay unit 110, after a period of time sufficiently longer than the time expected to be taken from the output of the signal for turning on first relay 111 to the closure of first relay 111 by relay unit 110. Accordingly, after first relay 111 is closed, supply of electric power from lamp ballast unit 101 via first relay 111 to first lamp 10A is started.

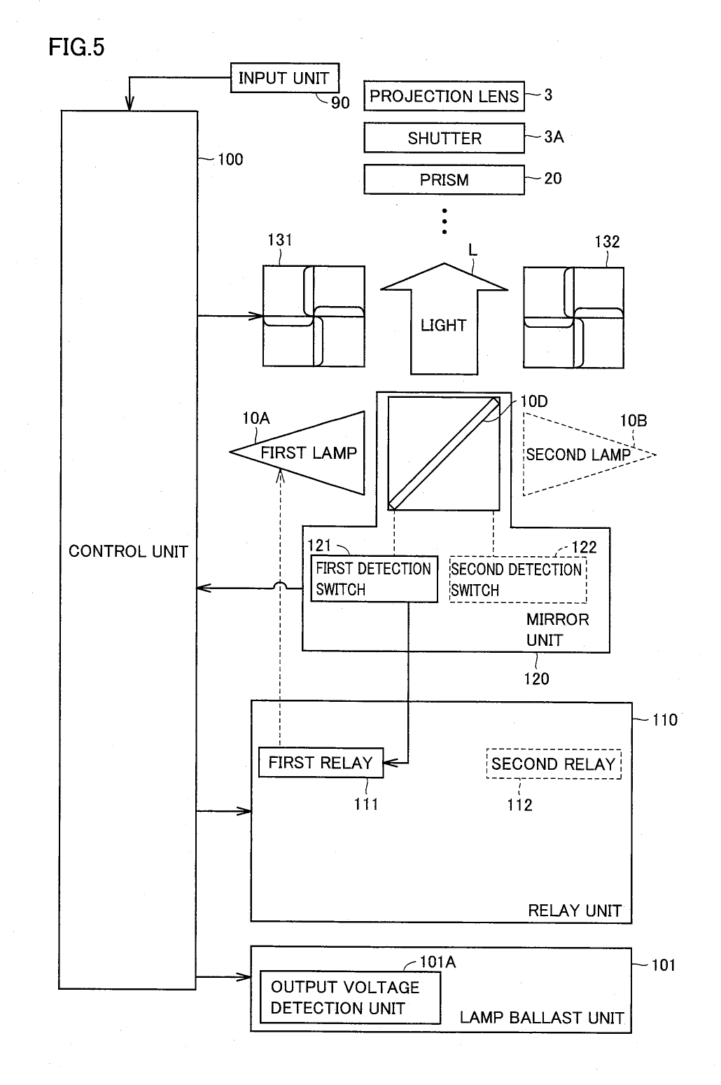

As a result of execution of the step of turning off the first lamp in step SA10 as described above, the state of connection of the components in the projector of the present embodiment changes from the state shown in FIG. 4 to the state shown in FIG. 5.

Referring to FIG. 5, in response to output of the signal from control unit 100 to lamp ballast unit 101 for stopping supply of electric power, supply of electric power from lamp ballast unit 101 to relay unit 110 is stopped.

When the condition is satisfied that the voltage value detected by output voltage detection unit 101A is equal to a value corresponding to the state where supply of electric power from lamp ballast unit 101 to relay unit 110 is stopped, control unit 100 proceeds to step SA20.

Referring back to FIG. 3, in step SA20, control unit 100 performs the step of opening contacts of first relay 111.

Specifically, control unit 100 outputs to relay unit 110 a signal for changing the state of first relay 111 from the closed state to the opened state. In the state where first lamp 10A is used as a light source, mirror 10D is in the first state and therefore, drive electric power is supplied to first relay 111 while drive electric power is not supplied to second relay 112. In step SA20, control unit 100 outputs to relay unit 110 a signal for keeping second relay 112 open.

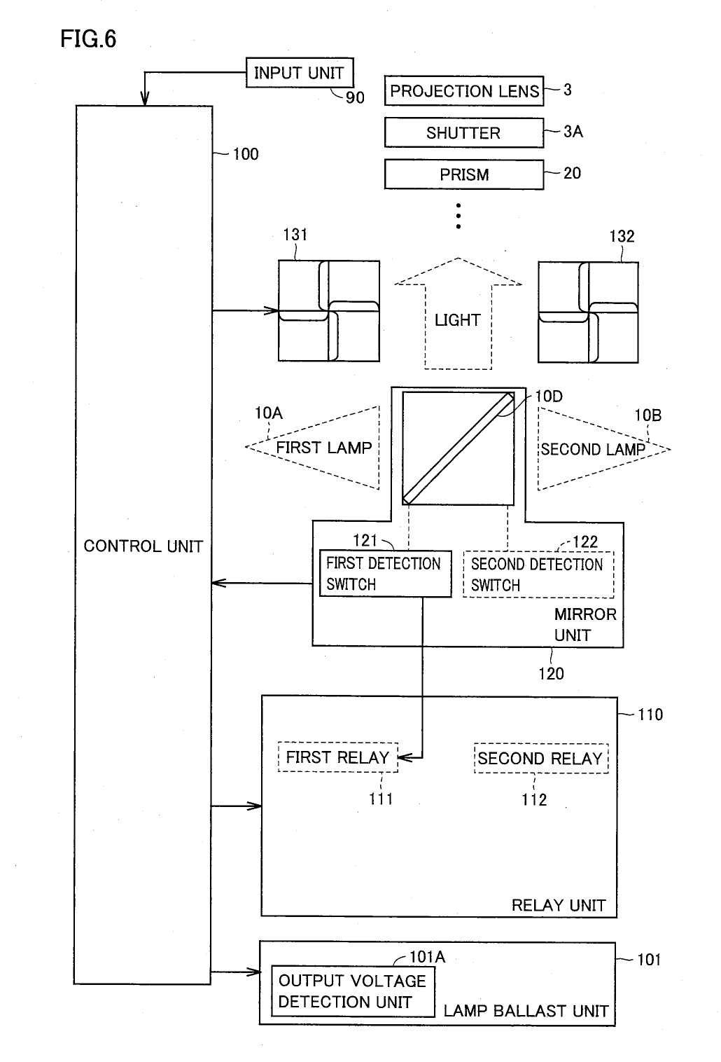

In response to execution of step SA20, the state of connection between the components in the projector of the present embodiment changes from the one shown in FIG. 5 to the one shown in FIG. 6.

Referring to FIG. 6, in response to output of the signal from control unit 100 to relay unit 110 for turning off first relay 111, first relay 111 is opened.

Referring back to FIG. 3, in step SA30, control unit 100 performs the step of switching mirror 10D.

Specifically, control unit 100 outputs a signal to mirror unit 120 for switching the state of mirror 10D from the first state to the second state. Then, in response to this signal, mirror 10D is rotated and accordingly the H signal is not output from first detection switch 121 while second detection switch 122 outputs the H signal in response to rotation of mirror 10D to the second state. Control unit 100 waits until second detection switch 122 outputs the H signal, and then proceeds to step SA40.

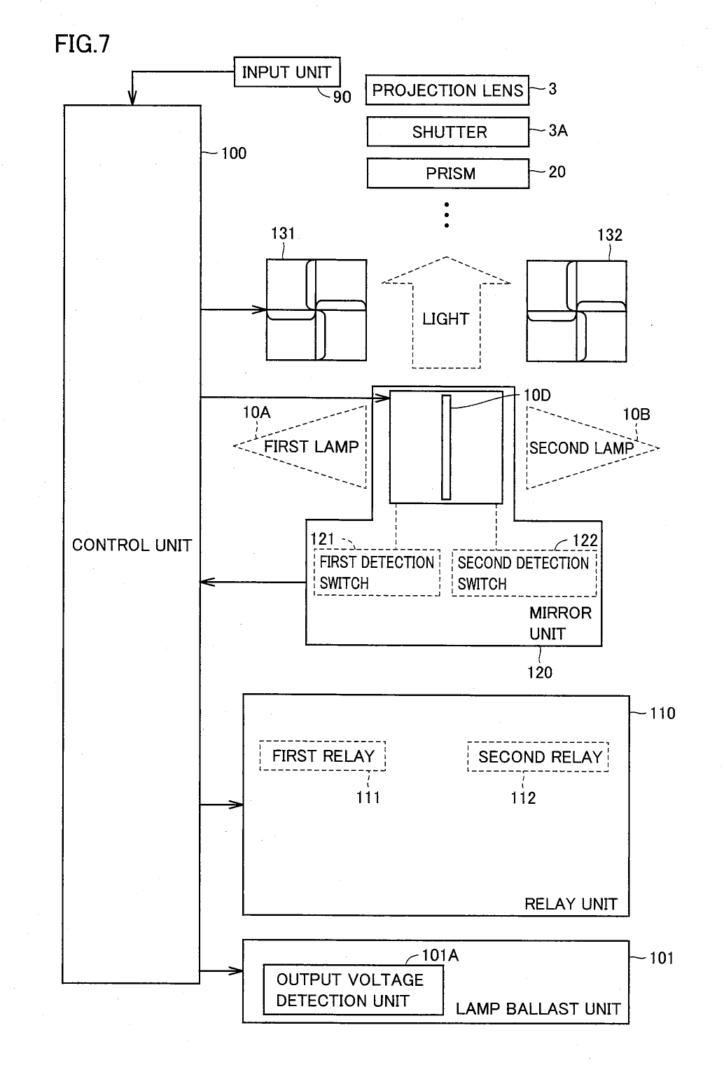

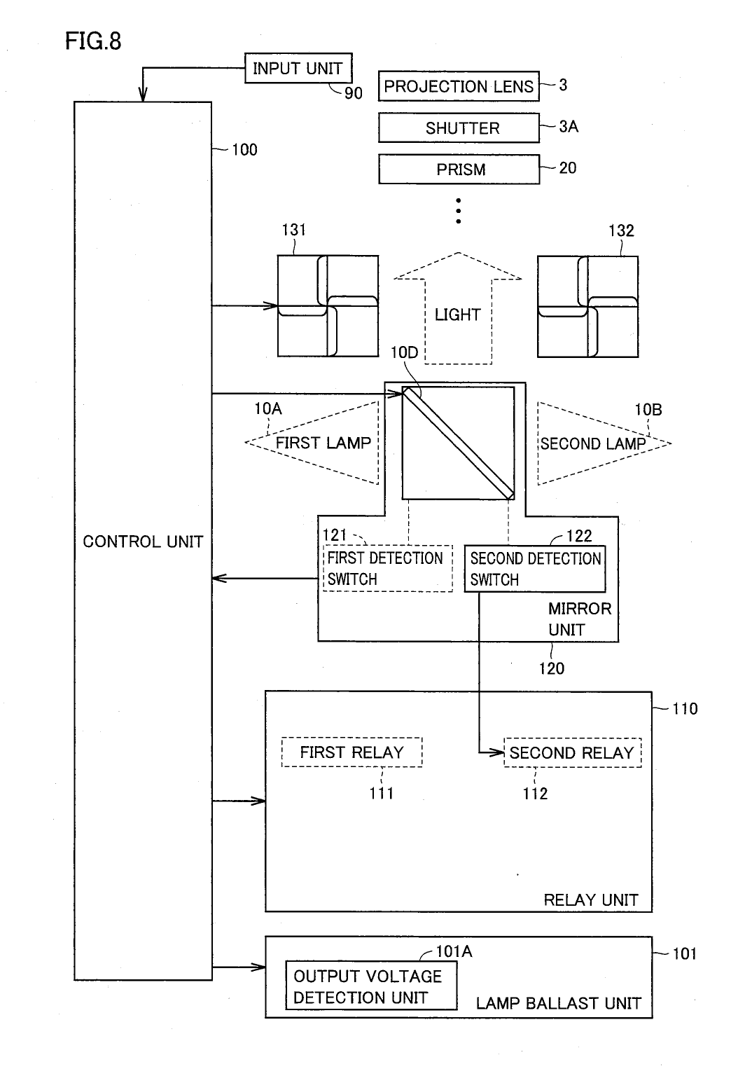

Execution of step SA30 causes the projector to change from the state shown in FIG. 6 to the state shown in FIG. 7 where mirror 10D is rotated. Mirror 10D is then caused to have the second state as shown in FIG. 8 where mirror 10D allows the light generated by second lamp 10B to proceed to prism 20.

In mirror unit 120, as mirror 10D starts rotating from the first state, the output of the H signal from first detection switch 121 is stopped.

As mirror 10D is rotated to the second state and the rotation of the mirror is accordingly stopped, second detection switch 122 detects this state to output the H signal to control unit 100 and relay unit 110.

Referring back to FIG. 3, in step SA40, control unit 100 performs the step of connecting contacts of second relay 112.

Specifically in step SA40, control unit 100 outputs to relay unit 110 a signal for turning off first relay 111 and turning on second relay 112.

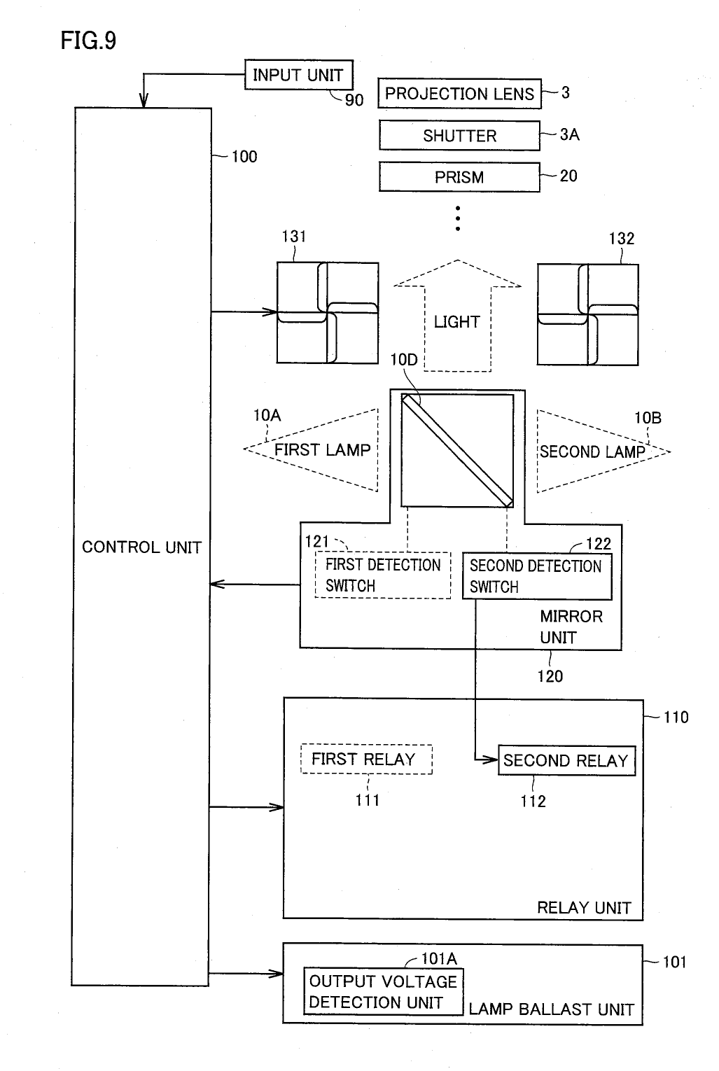

Execution of step SA40 changes the state of flow of signals in the projector from the one shown in FIG. 8 to the one shown in FIG. 9.

Referring to FIG. 9, since second detection switch 122 has already output the signal to relay unit 110, second relay 112 is ready to be supplied with drive electric power. In step SA40, second relay 112 is driven to the closed state based on the signal that is output from control unit 100 to relay unit 110 for turning on second relay 112.

After a period of time sufficiently longer than the time from the output of the signal to relay unit 110 to the closure of second relay 112 by relay unit 110 in step SA40, control unit 100 proceeds to step SA50.

Referring back to FIG. 3, in step SA50, control unit 100 performs the step of turning on second lamp 10B.

Specifically, control unit 100 causes lamp ballast unit 101 to start supplying electric power to relay unit 110, and starts driving exhaust fan 132 to start cooling second lamp 10B.

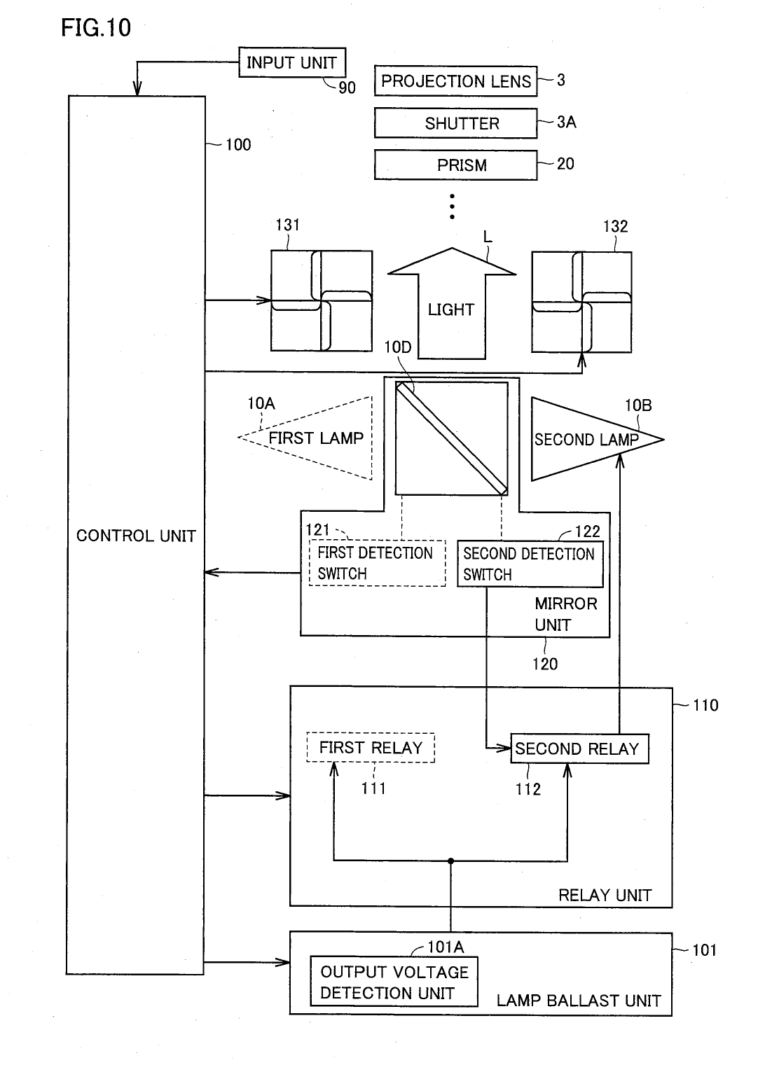

Through the process up to here in step SA50, the state of flow of signals in the projector is changed from the one shown in FIG. 9 to the one shown in FIG. 10.

Referring to FIG. 10, since second relay 112 has already been closed, electric power is supplied from lamp ballast unit 101 via second relay 112 to second lamp 10B, in response to start of supply of electric power from lamp ballast unit 101 to relay unit 110. As exhaust fan 132 is driven, cooling of second lamp 10B is also started.

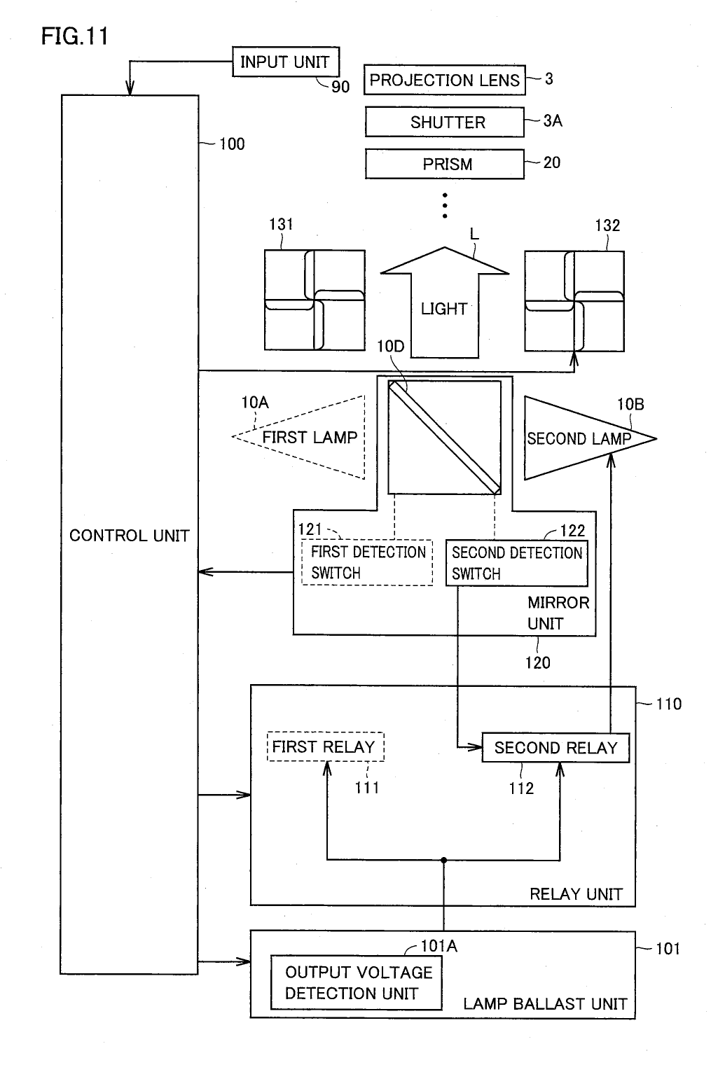

Referring back to FIG. 3, control unit 100 stops driving exhaust fan 131 for ending cooling of first lamp 10A which is turned off in step SA10. In this case, the output of the drive signal from control unit 100 to exhaust fan 131 is stopped as shown in FIG. 11.

Control unit 100 may stop driving exhaust fan 131 after a certain time from the time when supply of electric power from lamp ballast unit 101 to relay unit 110 is stopped in step SA10, or after a predetermined time from the time when supply of electric power to second lamp 10B is started in step SA50.

In the above-described process of switching a lamp, while the lamp to be used as a light source is switched from first lamp 10A to second lamp 10B, namely in the period where mirror 10D is switched from the first state to the second state (step SA30), both of first lamp 10A and second lamp 10B are turned off. Therefore, emission of light generated by these lamps to the outside via projection lens 3 is inhibited. In other words, control unit 100 performing the process of switching a lamp also serves as an inhibition unit.

In the present embodiment, the CPU in control unit 100 executes a program recorded on a storage device in control unit 100 to execute the process as described above with reference to FIG. 3 for example. The program may have been recorded in control unit 100 at the time of shipment of the projector, or may be downloaded via a network or the like to be recorded in control unit 100 if the projector has the communication capability, or the program recorded on a recording medium provided separately from the projector may be written to be recorded in control unit 100 if the projector can read information recorded on such a recording medium.

In the present embodiment, first lamp 10A and second lamp 10B are equivalent, first detection switch 121 and second detection switch 122 are equivalent, and first relay 111 and second relay 112 are equivalent. Therefore, in the case where the lamp to be used as a light source is switched from second lamp 10B to first lamp 10A, the first lamp and the second lamp may be replaced with each other in the process as described with reference to FIG. 3, and the first state and the second state of mirror 10D may be replaced with each other.

While exhaust fans 131, 132 are employed as cooling units for first lamp 10A and second lamp 10B in the present embodiment, the cooling units are not limited to the fans as long as the cooling unit has cooling ability such as a cooling apparatus using a liquid, for example.

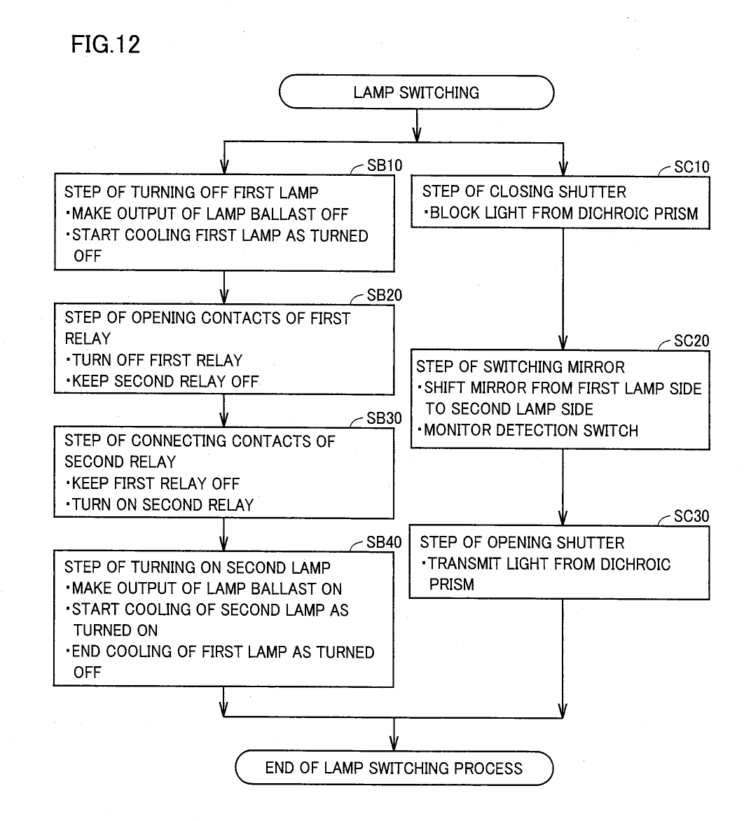

In the projector of the present embodiment, while the lamp to be used as a light source is switched from first lamp 10A to second lamp 10B, second lamp 10B may be turned on during the step of switching mirror 10D from the first state to the second state, so that display of an image by means of second lamp 10B may be started in an earlier stage. In this case, shutter 3A is used. A process of switching a lamp performed in this case will be described in detail with reference to FIG. 12 showing a flowchart for this process.

In the process of switching a lamp shown in FIG. 12, the process from step SB10 to step SB40 and the process from step SC10 to step SC30 are carried out in parallel.

Details of step SB10 to step SB40 are as follows. In step SB10, like step SA10, control unit 100 performs the step of turning off first lamp 10A and proceeds to step SB20.

In step SB20, like step SA20, control unit 100 performs the step of opening contacts of first relay 111 and proceeds to step SB30.

In step SB30, like step SA40, control unit 100 performs the step of connecting contacts of second relay 112, and proceeds to step SB40.

In step SB40, like step SA50, control unit 100 performs the step of turning on second lamp 10B.

Details of step SC10 to step SC30 are as follows.

In step SC10, control unit 100 causes shutter 3A to close and proceeds to step SC20.

In step SC20, like step SA30, control unit 100 performs the step of switching the mirror and proceeds to step SC30.

In step SC30, control unit 100 causes shutter 3A to open.

In the process of switching a lamp as described above with reference to FIG. 12, shutter 3A is closed before the step of switching the mirror (step SC20), and shutter 3A is opened after this process. Accordingly, it is ensured that, in the period in which the state of mirror 10D is changed between the first state and the second state, the light generated by first lamp 10A and second lamp 10B is not emitted to the outside of the projector via projection lens 3.

In the process of switching a lamp as described above with reference to FIG. 12, control unit 100 for opening and closing shutter 3A also serves as an inhibition unit.

In the projector implemented as an embodiment of the image display apparatus, a single power supply unit (lamp ballast unit 101) serving as a power supply supplies electric power to first lamp 10A and second lamp 10B. In the present embodiment, in the case where the intensity of light emitted from the image display apparatus to the outside may considerably varies, due to the fact that temporarily no electric power is supplied to both of the first and second lamps or shutter 3A is closed in the step of switching the lamp to which electric power is to be supplied between the first and second lamps, emission of the light to the outside is inhibited without exception. In this way, any discomfort that could be experienced by a viewer of the image display apparatus in such a case can be avoided.

Therefore, even if a single power supply unit is used to supply electric power to a plurality of lamps, namely even if respective power supply units are not provided for respective lamps, the lamp to be used can be changed without causing discomfort to a viewer of the image display apparatus. Accordingly, the cost, size and weight of the image display apparatus can be reduced without causing discomfort to the viewer.

Further, in the embodiment as described above, when electric power is to be supplied to first lamp 10A, first relay 111 is closed and then supply of electric power from lamp ballast unit 101 is started. When supply of electric power to first lamp 10A is to be stopped, supply of electric power from lamp ballast unit 101 is stopped and then first relay 111 is opened. Namely, supply of electric power from lamp ballast unit 101 to lamp 10A is started and stopped while first relay 111 is closed.

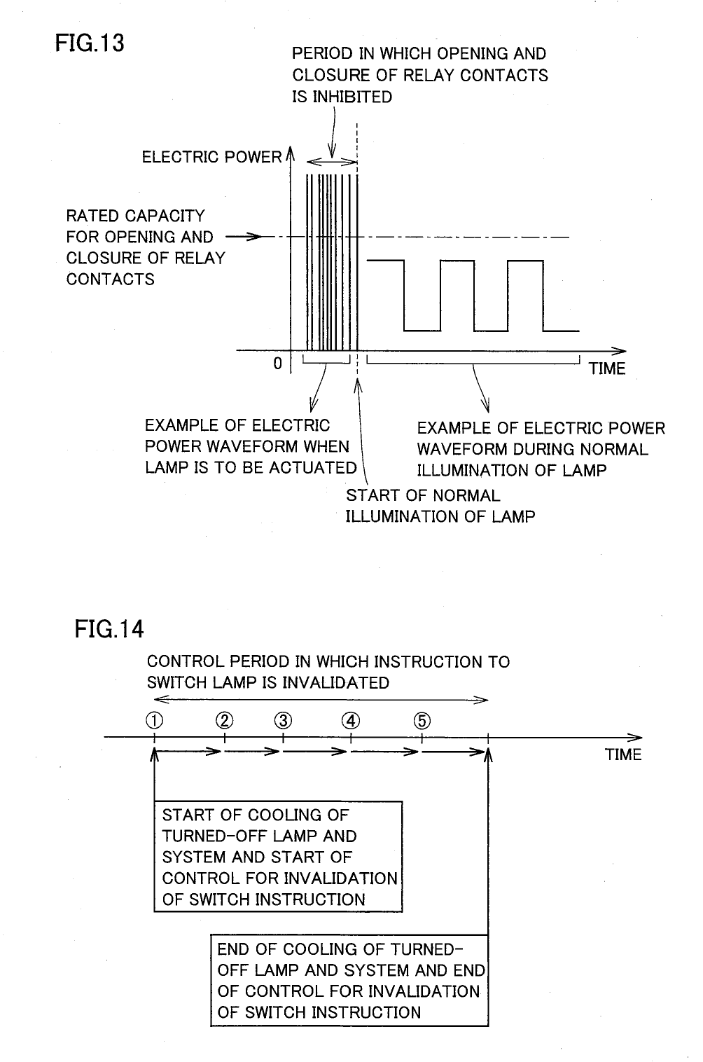

When supply of electric power from lamp ballast unit 101 is started, the electric power with the waveform shown in FIG. 13 as “example of electric power waveform when lamp is to be actuated” will be generated on the electrical circuit between lamp ballast unit 101 and first lamp 10A. In such a state, the rated capacity for opening and closure of first relay 111 as indicated by the broken line in FIG. 13 is exceeded, which may cause the event where arc discharge and resultant welding occurs to first relay 111.

In order to avoid such an event as described above, the present embodiment starts and stops supply of electric power from lamp ballast unit 101 to lamp 10A while first relay 111 is closed.

Thus, in the image display apparatus having a plurality of lamps such as projector, a single power supply unit (lamp ballast unit 101) is used while the safety is ensured at the time when the lamp to which electric power is to be supplied is switched from one to another. Accordingly, the manufacturing cost, size and weight of the image display apparatus can be reduced and the safety while the lamp to be used is switched is ensured.

When the electric power waveform during normal illumination of a lamp is the one shown as “example of electric power waveform during normal illumination of lamp” in FIG. 13, the electric power waveform of the circuit during normal illumination of the lamp is kept smaller than the rated capacity as described above. Therefore, even if the relay contacts are opened while the lamp remains on, the disadvantageous event such as welding as described above will not occur to first relay 111.

For a similar reason, supply of electric power from lamp ballast unit 101 to lamp 10B is started and stopped while second relay 112 is closed.

In the process of switching a lamp as described above with reference to FIG. 3, until a certain time has passed from the time when supply of electric power from lamp ballast unit 101 to relay unit 110 is stopped in step SA10, or until a predetermined time has passed from the time when supply of electric power to second lamp 10B is started in step SA50, the lamp used before switched (first lamp 10A) is cooled, namely exhaust fan 131 is driven. In order to surely cool the lamp in such a way, it is preferable that, in the period from the start of the process of switching a lamp to the time when exhaust fan 131 is stopped from being driven in step SA50, control unit 100 does not newly perform another process of switching a lamp.

In other words, in the present embodiment, it is preferable that, after the lamp switching process is started for switching the lamp to be used as a light source from first lamp 10A to second lamp 10B and until step SA50 is completed, control unit 100 does not newly start another process of switching a lamp (process for switching the lamp to be used as a light source from second lamp 10B to first lamp 10A), even if information is input to input unit 90 for instructing another lamp switching process to be newly started, or control unit 100 invalidates the input of such an instruction.

If the input of the instruction is not made invalid, actuation of the lamp (start of supply of electric power to the lamp) may fail due to insufficient cooling of the lamp and thus the lamp may not be turned on. As a result, an extra time will be required before the lamp is turned on again, including the time finally required for cooling the lamp, as compared with the case where the process of control as described above is followed.

If the failure of the actuation of the lamp is addressed by regarding it as an abnormality of the lamp in consideration of safety or the like, and control of the image display apparatus is stopped and thus the user has to operate the apparatus for restarting it, extra labor of the user is necessary, which considerably deteriorates the usefulness of the image display apparatus.

Further, insufficient cooling of the lamp as described above causes deterioration of the lamp itself, resulting in a damage or the like of the lamp. In such a case, the lifetime of the lamp may be shortened as compared with the case where the lamp is turned on and thereafter cooled for a normal cooling period. Such a damage to the lamp considerably deteriorates the usefulness and economy of the image display apparatus.

In the present embodiment, the input of an instruction to newly start another process is invalidated as described above to improve the usefulness of the image display apparatus. Further, the invalidation of the input ensures a cooling time for sufficiently cooling a lamp, so that deterioration of the usefulness and economy of the image display apparatus is avoided.

Such a period from the start of the lamp switching process to the start of another process to be newly performed, or the period of time in which an instruction to newly start another process is invalidated, may be defined as one of the specifications of the projector as shown in FIG. 14. Respective periods indicated by 1 to 5 in FIG. 14 correspond to respective periods of time necessary for respective steps SA10 to SA50 in FIG. 3.

It should be noted that respective lengths of time necessary for respective steps are different from each other. In the present embodiment, steps 1, 2 and 4 (step SA10, step SA20, step SA40) are performed in the substantially same period of time, and this time is shortest among periods 1 to 5 (step SA10 to step SA50). The second shortest period of the step is period 3 (step SA30). The longest period of the step as required is period 5 (step SA50). Period 5 (step SA50) is mainly occupied by the time required for cooling first lamp 10A which is turned off. In FIG. 14, the illustrated distance representing each period of the step does not correspond to the actual length of time required for performing the step.

It is supposed here that the lamp to which electric power is to be supplied is switched one after another. Then, as the time taken for switching, namely the period of time for which input of the instruction is invalidated as described above is shorter, the apparatus can more sensitively respond to user's instructions and thus the usefulness of the image display apparatus is excellent. On the contrary, as such a period of time is longer, the user has to wait until the invalidation of the input of the instruction is cancelled, which is troublesome to the user. Further, in some cases, the user is requested to confirm that the invalidation of the input of the instruction is cancelled and then input an instruction, which deteriorates the usefulness of the image display apparatus.

Shortening of such a period of time in which input of the instruction is invalidated is effective particularly in the case where the image display apparatus (projector) is used for presentation or exhibition. More specifically, if the lamp to be turned on is successively switched from one to another among a plurality of lamps mounted on the projector during preparation of or immediately before the presentation or exhibition, the shortening of the time for invalidation provides shortening of the time required for confirmation, which particularly improves the usefulness of the image display apparatus (projector).

The length of time for which exhaust fan 131 is driven in step SA50, the length of the time for which another lamp switching process is waited for, and the length of time for which input of the instruction is invalidated as described above can be shortened by improving the performance of lamp 10A and the cooling ability of exhaust fan 131, for example.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image display apparatus comprising:
a first lamp;
a second lamp;
a power supply unit for supplying electric power to said first lamp or said second lamp; and
a control unit for inhibiting light generated by said first lamp or said second lamp from being emitted outside, while a lamp to which electric power is to be supplied from said power supply unit is switched between said first lamp and said second lamp.

2. The image display apparatus according to claim 1, further comprising:
a first relay for switching an electric circuit including said power supply unit and said first lamp between an opened state and a closed state; and
a second relay for switching an electric circuit including said power supply unit and said second lamp between an opened state and a closed state, wherein
while a lamp to which electric power is to be supplied from said power supply unit is switched from said first lamp to said second lamp, said control unit stops supply of electric power from said power supply unit to said first lamp and thereafter opens said first relay, and closes said second relay and thereafter starts supply of electric power from said power supply unit to said second lamp.

3. The image display apparatus according to claim 1, further comprising a switch unit assuming a first state for directing light generated by said first lamp to the outside for use in display of an image, and a second state for directing light generated by said second lamp to the outside for use in display of an image, wherein
said control unit executes control such that, while a lamp to which electric power is to be supplied from said power supply unit is switched from said first lamp to said second lamp, the state of said switch unit is changed from said first state to said second state, and
said control unit stops supply of electric power from said power supply unit to said first lamp while changing the state of said switch unit.

4. The image display apparatus according to claim 1, further comprising a shutter for blocking light generated by said first lamp from being emitted outside, wherein
while a lamp to which electric power is to be supplied from said power supply unit is switched from said first lamp to said second lamp, said control unit closes said shutter from start to end of control for switching the lamp from said first lamp to said second lamp.

5. The image display apparatus according to claim 1, further comprising:
a first cooling unit for cooling said first lamp; and
a second cooling unit for cooling said second lamp, wherein
said control unit controls operation of said first cooling unit and said second cooling unit, and
in a case where a lamp to which electric power is to be supplied from said power supply unit is switched from said first lamp to said second lamp, said control unit causes said second cooling unit to start cooling said second lamp when supply of electric power from said power supply unit to said second lamp is started, and causes said first cooling unit to stop cooling said first lamp after a predetermined time from start of supply of electric power to said second lamp.

6. The image display apparatus according to claim 1, further comprising a reception unit for receiving input of information designating a lamp to be used for display of an image, wherein
said control unit switches a lamp to which electric power is to be supplied from said power supply unit, based on the input of information to said reception unit, and
said reception unit invalidates said input of information for a period in which a lamp to which electric power is to be supplied from said power supply unit is switched between said first lamp and said second lamp, and for a predetermined period after completion of said switching between said first lamp and said second lamp.

7. A method of controlling an image display apparatus including a first lamp, a second lamp and a power supply unit for supplying electric power to said first lamp or said second lamp,
light generated by said first lamp or said second lamp being inhibited from being emitted outside while a lamp to which electric power is to be supplied is switched between said first lamp and said second lamp.
